(19) United States
(12) Patent Application Publication
(10) Pub. No.: US 2015/0324447 A1
(43) Pub. Date: Nov. 12, 2015

(54) HYBRID DATABASE MANAGEMENT SYSTEM AND METHOD OF MANAGING TABLES THEREIN

(71) Applicant: Altibase Corp., Seoul (KR)

(72) Inventors: Sung Min Kim, Seoul (KR); Jung Keun Kim, Gyeonggi-do (KR)

(21) Appl. No.: 14/706,554

(22) Filed: May 7, 2015

(30) Foreign Application Priority Data
May 8, 2014 (KR) 10-2014-0054931
Apr. 10, 2015 (KR) 10-2015-0051142

(51) Int. Cl. G06F 17/30

(52) U.S. Cl. CPC G06F 17/30598; G06F 17/30486; G06F 17/30312; G06F 17/30917

(57) ABSTRACT

A method of managing tables in a hybrid database management system includes: classifying data constituting tables with respect to each of partitions; classifying the data constituting the partitions into hot data and cold data, based on data attribute, with respect to each of the partitions; storing the hot data and the cold data in different logical storage spaces; checking data attributes of the hot data and the cold data at preset periods and reclassifying the hot data and the cold data based on the checked data attributes; and updating logical storage spaces of the reclassified hot data and the reclassified cold data.

### CROSS-REFERENCE TO RELATED APPLICATIONS

This application claims the benefit of Korean Patent Application No. 10-2014-0054931, filed on May 8, 2014, and Korean Patent Application No. 10-2015-0051142, filed on Apr. 10, 2015, in the Korean Intellectual Property Office, the disclosures of which are incorporated herein in their entireties by reference.

### BACKGROUND

1. Field

One or more exemplary embodiments relate to a hybrid database management system (DBMS), and more particularly, to a hybrid DBMS and a method of managing partitions or data constituting a table therein.

2. Description of the Related Art

In a disk database management system (DBMS), table data is basically stored in a disk, and whenever needed, the table data is used by being loaded into a buffer of a main memory. Due to these characteristics, the disk DBMS is suitable for storage and processing of a large amount of data. On the other hand, in an in-memory DBMS, entire table data are loaded into a main memory at the time of startup. Then, the data loaded into the memory is referenced by using memory pointers.

In the case of the disk DBMS, there is no assumption that table data is loaded into a memory. Hence, it is difficult to directly access data by using memory pointers. In addition, in the case of the in-memory DBMS, it is necessary to load entire table data into the main memory. Hence, there is a limitation in processing data of a table having a larger capacity than that of the main memory.

### SUMMARY

One or more exemplary embodiments include a hybrid database management system (DBMS) and a method of managing tables therein, capable of overcoming limitations of a disk DBMS and an in-memory DBMS by using a hybrid DBMS having advantages of the disk DBMS and the in-memory DBMS.

One or more exemplary embodiments include a hybrid DBMS and a method of managing tables therein, capable of resolving a problem that it is difficult to store an entire large-capacity table in a main memory in a case where part of frequently used small-capacity data is included in one large-capacity table in an in-memory DBMS.

One or more exemplary embodiments include a hybrid DBMS and a method of managing tables therein, capable of overcoming limitations in performing processing at high speed in a case where an entire large-capacity table including frequently used small-capacity data is stored in a disk.

Additional aspects will be set forth in part in the description which follows and, in part, will be apparent from the description, or may be learned by practice of the presented embodiments.

According to one or more exemplary embodiments, a hybrid database management system includes: a physical table mapping unit configured to perform physical mapping on tables; and a logical table mapping unit configured to perform logical mapping on tables, wherein the physical table mapping unit selects a main memory or a disk as a location where entire data constituting tables is to be loaded in units of tables, the main memory and the disk being physical storage spaces, and the logical table mapping unit classifies data into hot data and cold data, based on attribute of data, in units of data constituting the tables with respect to each of the tables and stores the hot data and the cold data in different logical storage spaces.

According to one or more exemplary embodiments, a hybrid database management system includes: a partition dividing unit configured to divide entire data constituting tables into partitions with respect to each of the tables; and a logical table mapping unit configured to classify the data of the partitions into hot data and cold data according to a usage frequency setting condition and respectively maps the hot data and the cold data into a memory tablespace and a disk tablespace which are storage spaces having different data access methods.

According to one or more exemplary embodiments, a hybrid database management system includes: a memory tablespace configured to load table data into a main memory and access the table data loaded into the main memory by using a memory pointer; a disk tablespace configured to load table data into a disk and, when needed, access the table data by loading the table data in a buffer of the main memory; and a hybrid partitioned table configured to perform loading in units of data constituting tables with respect to each of the tables, wherein the hybrid partitioned table classifies the data constituting the tables with respect to each of the partitions, classify the data constituting the partitions into hot data and cold data, based on attribute of data, with respect to each of the partitions, and store the hot data and the cold data in different logical storage spaces.

According to one or more exemplary embodiments, a method of managing tables in a hybrid database management system includes: classifying data constituting tables with respect to each of partitions; classifying the data constituting the partitions into hot data and cold data, based on data attribute, with respect to each of the partitions; storing the hot data and the cold data in different logical storage spaces; checking data attributes of the hot data and the cold data at preset periods and reclassifying the hot data and the cold data based on the checked data attributes; and updating logical storage spaces of the reclassified hot data and the reclassified cold data.

According to one or more exemplary embodiments, a method of managing tables in a hybrid database management system includes: classifying, by a hybrid partitioned table, data into hot data and cold data, based on data attribute, in units of data constituting tables with respect to each of the tables; storing the hot data and the cold data in different logical storage spaces; determining whether the data attribute is changed; and when it is determined that the data attribute is changed, changing a logical storage space of the data.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates an internal configuration of a hybrid database management system (DBMS), according to an exemplary embodiment;

FIG. 2 illustrates an internal configuration of a hybrid DBMS, according to another exemplary embodiment;

FIGS. 3 and 4 illustrate a process of classifying data into hot data and cold data and storing the hot data and the cold data in different logical storage spaces, according to an exemplary embodiment;

FIG. 5 illustrates a process of dividing partitions in a hybrid partitioned table, according to an exemplary embodiment;

FIG. 6 illustrates a process of reclassifying hot data and cold data in a hybrid partitioned table, according to an exemplary embodiment;

FIG. 7 illustrates a process of adding a hot data partition in a hybrid partitioned table, according to an exemplary embodiment;

FIGS. 8 to 10 illustrate a process of classifying data into hot data and cold data in a hybrid partitioned table, based on attribute of data, according to an exemplary embodiment; and

FIG. 11 is a flowchart of a method of managing a table in a hybrid DBMS, according to an exemplary embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the exemplary embodiments are merely described below, by referring to the figures, to explain aspects of the present description.

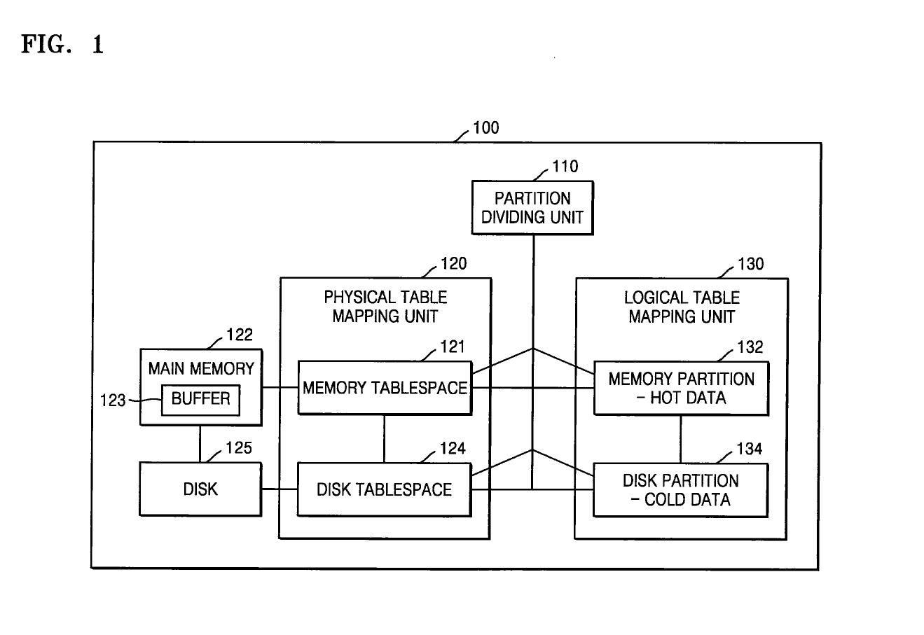

FIG. 1 illustrates an internal configuration of a hybrid database management system (DBMS) 100, according to an exemplary embodiment.

According to the exemplary embodiment, the hybrid DBMS 100 may support a function of loading data in units of tables or a function of loading data in units of data of partitions constituting a table.

To this end, the hybrid DBMS 100 may include a partition dividing unit 110, a physical table mapping unit 120, and a logical table mapping unit 130.

The partition dividing unit 110 may be configured to divide partitions in a partitioned table including a plurality of partitions. The partitions constituting one partitioned table may be configured to have different tablespaces.

The hybrid DBMS 100 may support a function of storing entire data constituting each table in either a main memory 122 or a disk 125 in units of tables through the physical table mapping unit 120.

The physical table mapping unit 120 may include a memory tablespace 121 and a disk tablespace 124.

The memory tablespace 121 may be configured to load table data into the main memory 122 and reference the table data loaded into the main memory 122 by using a memory pointer. The memory tablespace 121 may load entire data belonging to the memory tablespace 121 in the main memory 122 at the time of startup of the hybrid DBMS 100.

The disk tablespace 124 may be configured to load the table data into the disk 125 and, only when needed, use data by loading necessary data into a buffer 123 of the main memory 122 among the table data loaded into the disk 125.

The hybrid DBMS 100 may classify data into hot data and cold data, based on attribute of data, in units of individual data constituting the partitions created by the partition dividing unit 110. Thereafter, the hybrid DBMS 100 may support a function of storing the hot data and the cold data in different logical storages 132 and 134. The logical storages 132 and 134 may include a memory partition 132 that stores the hot data and a disk partition 134 that stores the cold data.

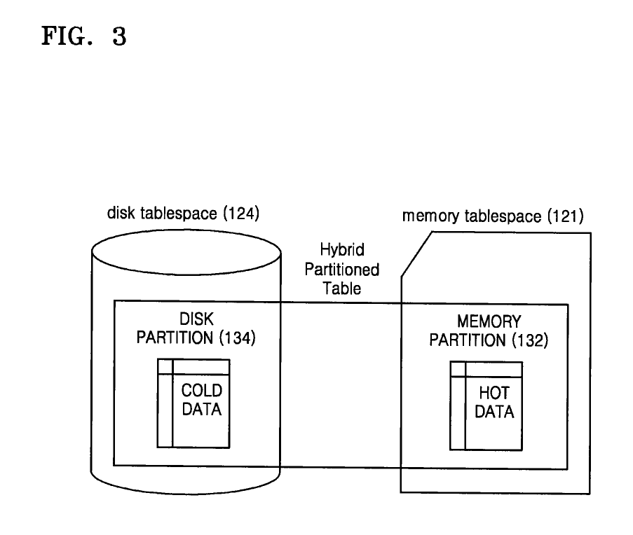

Referring to FIG. 3, the logical table mapping unit 130 may store the cold data and the hot data, respectively, in the disk partition 134 and the memory partition 132 among the partitions constituting the partitioned table. The hot data may represent data that satisfies a preset condition, and the cold data may represent data that does not satisfy the preset condition.

In an exemplary embodiment, it is assumed that the partitions constituting the partitioned table include partition 1, partition 2, partition 3, partition 4, . . . , partition 8. In this case, the logical table mapping unit 130 may classify some of data constituting partition 1 into hot data and classify the others into cold data.

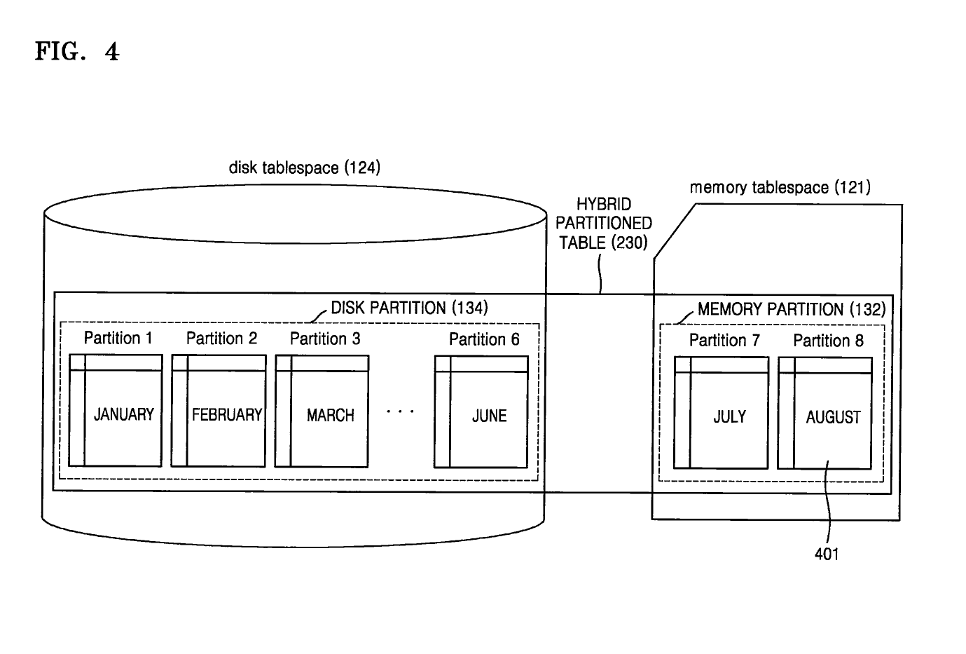

In addition, referring to FIG. 4, the logical table mapping unit 130 may classify data belonging to partition 1, partition 2, partition 3, . . . , and partition 6 into cold data and classify data belonging to partition 7 and partition 8 into hot data in the partitioned table.

The logical table mapping unit 130 may reclassify the hot data into the cold data when it is determined that the corresponding data does not satisfy the preset condition. In addition, the logical table mapping unit 130 may reclassify the cold data into the hot data when it is determined that data having not satisfied the preset condition satisfies the preset condition. The determination may be performed at preset periods or according to settings of an administrator.

When the attribute of data is changed from the hot data to the cold data or from the cold data to the hot data, the logical table mapping unit 130 may change a logical storage space, in which the corresponding data is to be stored, from the memory partition 132 to the disk partition 134 or from the disk partition 134 to the memory partition 132.

According to an exemplary embodiment, the hot data may represent data satisfying the preset condition among the data of the partitions constituting the partitioned table, and the cold data may represent data except for the hot data.

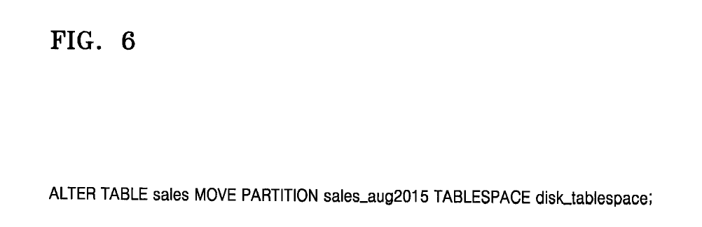

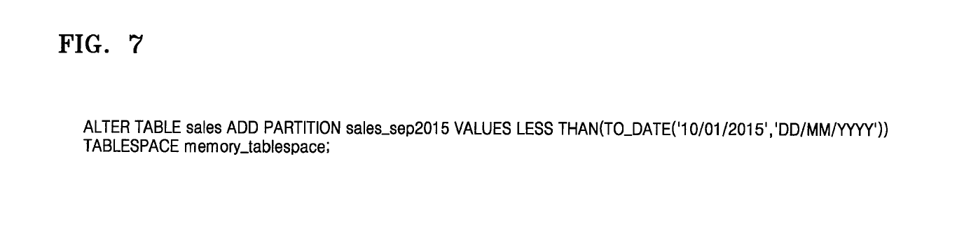

According another exemplary embodiment, the hot data may be set to represent data that is within a preset period and the cold data may be set to represent data that is out of the preset period. A process of classifying data into hot data and cold data, based on attribute of data, according to an exemplary embodiment, will be described below with reference to FIGS. 6 and 7.

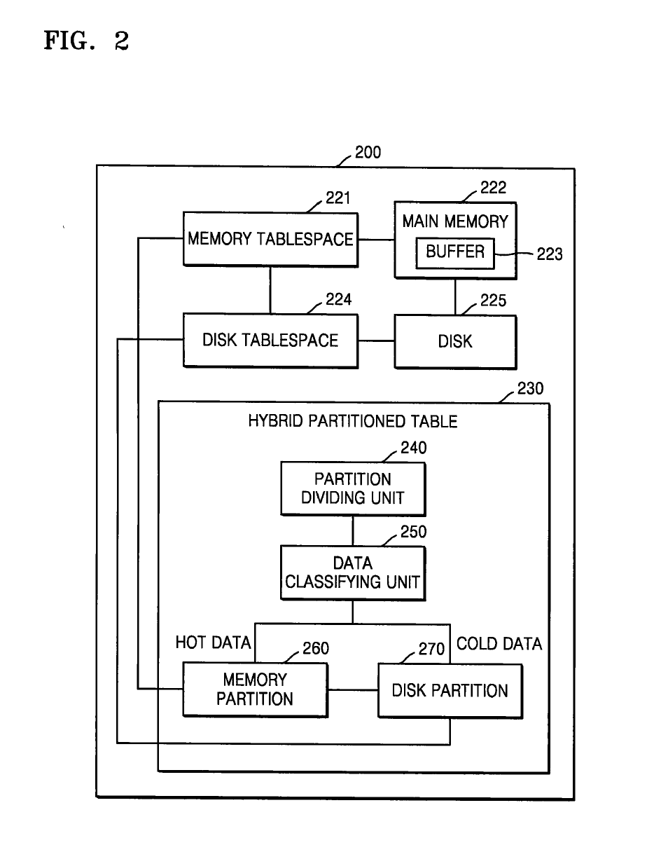

FIG. 2 illustrates an internal configuration of a hybrid DBMS 200, according to another exemplary embodiment. In FIG. 2, the descriptions about the elements of FIG. 1 will also be applied to the same elements as those illustrated in FIG. 2.

The hybrid DBMS 200 may include a memory tablespace 221, a disk tablespace 224, and a hybrid partitioned table 230.

The hybrid DBMS 200 may store entire data constituting each table in either a main memory 222 or a disk 225 in units of tables through the memory tablespace 221 or the disk tablespace 224.

The memory tablespace 221 may be configured to load entire data belonging to the memory tablespace 221 into the main memory 222 at the time of startup of the hybrid DBMS 200 and reference table data loaded into the main memory 222 by using a memory pointer.

The disk tablespace 224 may be configured to load the table data into the disk 225 and, only when needed, use data by loading necessary data into a buffer 223 of the main memory 222 among the table data loaded into the disk 225.

According to an exemplary embodiment, the hybrid DBMS 200 may divide data constituting the partitioned table into partitions in the hybrid partitioned table 230, classify data of the partitions into hot data and cold data, and store the hot data and the cold data in different logical storages 260 and 270, that is, a memory partition 260 and a disk partition 270. The hot data may be stored in the memory partition 260 and the cold data may be stored in the disk partition 270. According to an exemplary embodiment, the hybrid partitioned table 230 illustrated in FIG. 2 may perform all functions of the logical table mapping unit (130 in FIG. 1).

FIGS. 3 and 4 illustrate a process of classifying data into hot data and cold data and storing the hot data and the cold data in different logical storage spaces, according to an exemplary embodiment. In addition, FIGS. 3 and 4 illustrate a relationship between a logical storage space and a physical storage space.

Referring to FIGS. 1 and 3, the hot data stored in the memory partition 132 as an example of the logical storage space may be loaded into the memory tablespace 121. In addition, data stored in the disk partition 134 may be stored in the disk tablespace 124.

The entire hot data loaded into the memory tablespace 121 may be loaded into the main memory 122 at the time of startup of the hybrid DBMS 200. The hybrid DBMS 200 may reference the hot data stored in the main memory 122 by using the memory pointer.

In addition, the data stored in the disk tablespace 124 may be loaded into the disk 125 and, only when needed, use data by loading necessary data into the buffer 123 of the main memory 122.

According to an exemplary embodiment, the hybrid DBMS 200 may be configured to classify data into hot data when the data has been used at, for example, a preset usage frequency or more, load the data into the memory tablespace 121. In addition, the hybrid DBMS 200 may be configured to classify data into cold data when the data has not been frequently used, and store the data in the disk tablespace 124.

Furthermore, the hybrid DBMS 200 may be configured to classify data into hot data when the data has recent data that is within a preset period, and classify the other data into cold data, thus satisfying requirements for work efficiency and high-speed processing.

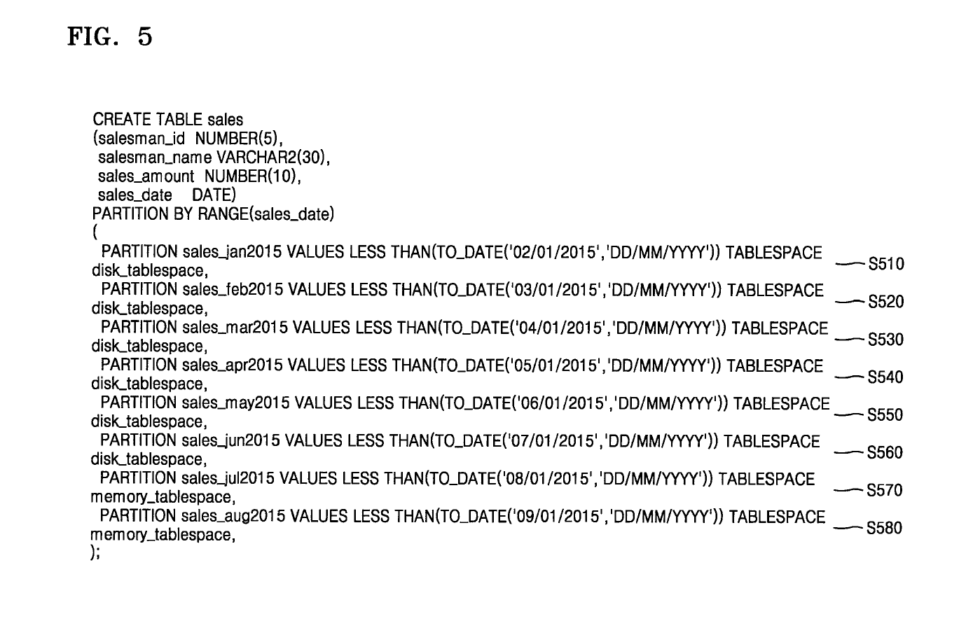

FIG. 5 illustrates a process of dividing partitions in a hybrid partitioned table, according to an exemplary embodiment.

Referring to FIG. 5, the hybrid partitioned table including partitions of January to August may be created. Thereafter, referring to FIG. 3, each of the partitions constituting the hybrid partitioned table may be divided and data belonging to each of the partitions may be classified into hot data and cold data, based on attribute of data.

According to an exemplary embodiment, data may be classified into hot data and cold data in units of data belonging to the partition. According to another exemplary embodiment, data may be classified into hot data and cold data in units of partitions.

Referring to FIGS. 3 and 5, the partitions of January to June may be classified into cold data and be stored in the disk tablespace 124 (S510 to S560), and the partitions of July and August may be classified into hot data and be stored in the memory tablespace 121 (S570 and S580).

FIG. 6 illustrates a process of reclassifying data into hot data and cold data in the hybrid partitioned table 230 of FIG. 2, according to an exemplary embodiment.

Referring to FIGS. 3 and 6, when partition 8 401 is changed from hot data to cold data, the hybrid partitioned table (230 in FIG. 2) may change a storage space of the partition 8 401. The hybrid partitioned table (230 in FIG. 2) may move a logical storage space of the partition 8 401 from the memory partition (132 in FIG. 4) to the disk partition (134 in FIG. 3). In addition, the hybrid partitioned table (230 in FIG. 2) may move a physical storage space from the memory tablespace (121 in FIG. 4) to the disk tablespace (124 in FIG. 4).

FIG. 7 illustrates a process of adding a hot data partition in the hybrid partitioned table 230, according to an exemplary embodiment.

Referring to FIGS. 3 and 7, in the case of addling the sales of September, partition 9 may be added. In this case, when it is assumed that data belonging to partition 9 is recent data satisfying a preset hot data usage condition, the hybrid partitioned table 230 may store partition 9 in the memory partition (132 in FIG. 4). In addition, hot data may be added to the memory tablespace (121 in FIG. 4) by the method of FIG. 7.

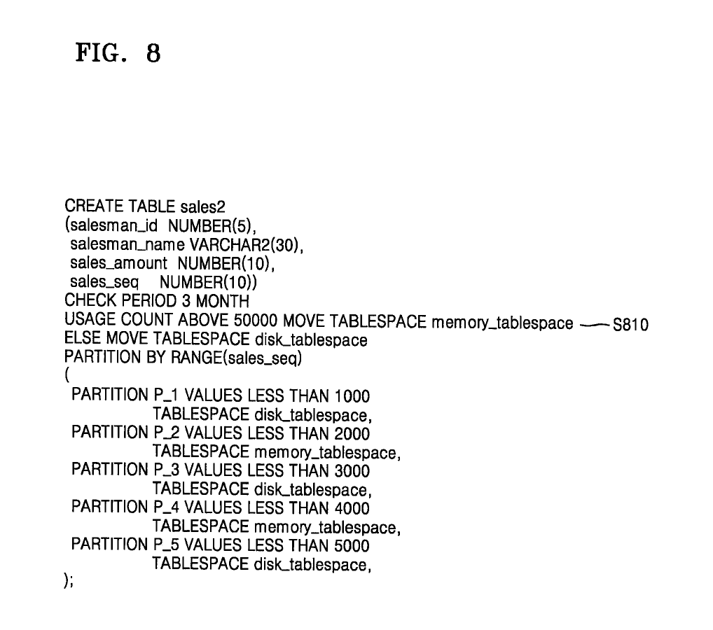

FIGS. 8 to 10 illustrate a process of classifying data into hot data and cold data based on attribute of data in a hybrid partitioned table, according to an exemplary embodiment.

FIG. 8 illustrates an example in which a periodic usage frequency is set as attribute of data. The hybrid partitioned table may classify data into hot data when the usage frequency of the data exceeds 50,000 times for three months, and classify the other data into cold data (S810).

According to an exemplary embodiment, the hybrid partitioned table may move data to the memory tablespace when the accumulated number of times of usage of the data exceeds 50,000 times for three months, with respect to the partitions belonging to the disk tablespace. The hybrid partitioned table may move data to the disk tablespace when the accumulated number of times of usage of the data is 50,000 times or less for three months, with respect to the partitions belonging to the memory tablespace. Although the classification and movement of data in units of partitions have been described, data may also be classified and moved in units of data belong to the partition.

In an exemplary embodiment, the hybrid partitioned table may use all three types of partitions, that is, range, hash, and list.

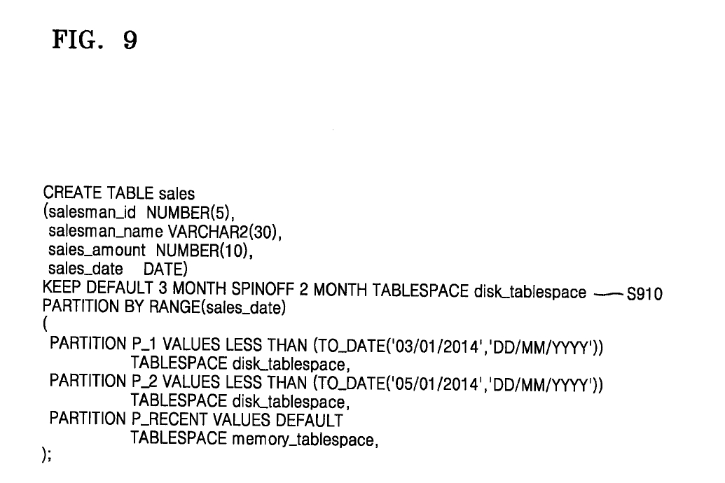

FIG. 9 illustrates a process of spinning off past data in units of time in the hybrid partitioned table, according to an exemplary embodiment. Specifically, data may be classified into hot data when the data has a larger value than an upper limit of the partition by about three months to about five months, and the other data may be classified into cold data (S910).

According to an exemplary embodiment, the hybrid partitioned table may reclassify data into cold data when the data is out of a preset period of two months, thus efficiently utilizing the finite storage space of the main memory. That is, the storage space of the data reclassified into the cold data may be changed to the disk tablespace.

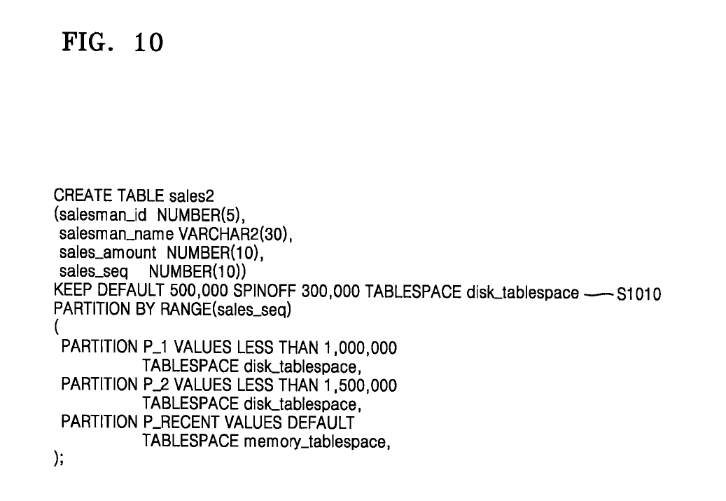

FIG. 10 illustrates a process of spinning off data in units of numbers in the hybrid partitioned table, according to an exemplary embodiment. Specifically, data may be classified as hot data when the data has a larger value than an upper limit of the partition by about 500,000 to about 800,000, and the other data may be classified into cold data (S1010).

According to an exemplary embodiment, the hybrid partitioned table may classify data as hot data when the data is in a specific number range, and reclassify the other data into cold data.

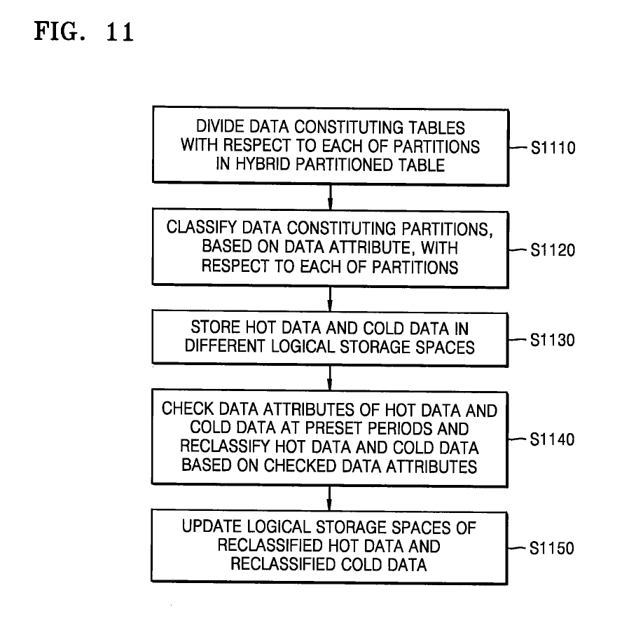

FIG. 11 is a flowchart of a method of managing tables in a hybrid DBMS, according to an exemplary embodiment.

A hybrid partitioned table may classify data constituting a table with respect to each partition (S1110). The hybrid partitioned table may classify data constituting a partition into hot data and cold data, based on attribute of data, with respect to each partition (S1120). Since the process of classifying the data into the hot data and the cold data has been described above with reference to FIGS. 8 to 10, a detailed description thereof will be omitted.

The hybrid partitioned table may store the hot data and the cold data in different logical storage spaces (S1130). Referring to FIGS. 2 and 3, the hot data may be stored in the memory partition among the logical storage spaces and the cold data may be stored in the disk partition among the logical storage spaces.

The hybrid partitioned table may check data attributes of the hot data and the cold data at preset periods and reclassify the hot data and the cold data based on the checked data attributes (S1140).

The logical storage spaces of the hot data and the cold data after the reclassification may be updated (S1150). For example, when the data is changed from the hot data to the cold data, the logical storage space may be changed from the memory partition to the disk partition. Accordingly, the physical storage space also may be changed from the memory tablespace to the disk tablespace.

In addition, when the data is changed from the cold data to the hot data, the logical storage space may be changed from the disk partition to the memory partition. Accordingly, the physical storage space also may be changed from the disk tablespace to the memory tablespace.

According to another exemplary embodiment, referring to FIG. 1, the logical table mapping unit (130 in FIG. 1) may perform operations S1120 to S1140 on the partitions created by the partition dividing unit (110 in FIG. 1).

As described above, according to the one or more of the above exemplary embodiments, it is possible to resolve a problem that it is difficult to store the entire large-capacity table in the main memory in a case where part of frequently used small-capacity data is included in one large-capacity table in the in-memory DBMS.

In addition, it is possible to perform processing at high speed by loading small-capacity data into the memory even when an entire large-capacity table including frequently used small-capacity data is stored in the disk.

Furthermore, it is possible for a user to manage hot data and cold data in a convenient and efficient manner by supporting one hybrid partitioned table to the user as an interface.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the inventive concept as defined by the following claims.

What is claimed is:

1. A hybrid database management system comprising:
a physical table mapping unit configured to perform physical mapping on tables; and
a logical table mapping unit configured to perform logical mapping on tables,
wherein the physical table mapping unit selects a main memory or a disk as a location where entire data constituting tables is to be loaded in units of tables, the main memory and the disk being physical storage spaces, and
the logical table mapping unit classifies data into hot data and cold data, based on attribute of data, in units of data constituting the tables with respect to each of the tables and stores the hot data and the cold data in different logical storage spaces.

2. The hybrid database management system of claim 1, wherein the hot data is data satisfying a preset usage condition among the data constituting the tables, and the cold data is data except for the hot data among the data constituting the tables.

3. The hybrid database management system of claim 2, wherein when the attribute of the data constituting the tables is changed from the hot data to the cold data or from the cold data to the hot data, the logical table mapping unit changes a logical storage space where the data is to be stored.

4. The hybrid database management system of claim 1, wherein the different logical storage spaces include a memory partition in which the hot data is stored and a disk partition in which the cold data is stored.

5. The hybrid database management system of claim 4, wherein the data stored in the memory partition is loaded into the main memory,
the main memory references the stored data by using a memory pointer; and
the data stored in the disk partition is stored in the disk, and uses data by loading necessary data into a buffer of the main memory among the data stored in the disk.

6. The hybrid database management system of claim 1, wherein the physical table mapping unit comprises:
a memory tablespace configured to load table data into the main memory and reference the table data loaded into the main memory by using a memory pointer; and
a disk tablespace configured to load the table data into the disk and, only when needed, use data by loading necessary data into a buffer of the main memory among the table data loaded into the disk.

7. The hybrid database management system of claim 6, wherein the memory tablespace loads both the hot data and the table data belonging to the memory tablespace into the main memory at the time of startup of the hybrid database management system.

8. The hybrid database management system of claim 1, wherein when data is classified into the hot data if the data attribute of the data is within a preset recent period and data is classified into the cold data if the data attribute of the data is out of the preset recent period, the logical table mapping unit reclassifies the data into the cold data if it is determined that the data classified into the hot data is out of the preset recent period.

9. The hybrid database management system of claim 8, wherein when the attribute of the data constituting the tables is changed from the hot data to the cold data, the logical table mapping unit changes a logical storage space where the data is to be stored.

10. The hybrid database management system of claim 1, wherein the hot data is recent data that is within a preset period among the data constituting the tables, and the cold data is data that is out of the preset period.

11. A hybrid database management system comprising:
a partition dividing unit configured to divide entire data constituting tables into partitions with respect to each of the tables; and
a logical table mapping unit configured to classify the data of the partitions into hot data and cold data according to a usage frequency setting condition and respectively maps the hot data and the cold data into a memory tablespace and a disk tablespace which are storage spaces having different data access methods.

12. A hybrid database management system comprising:
a memory tablespace configured to load table data into a main memory and access the table data loaded into the main memory by using a memory pointer;
a disk tablespace configured to load table data into a disk and, when needed, access the table data by loading the table data in a buffer of the main memory; and
a hybrid partitioned table configured to perform loading in units of data constituting tables with respect to each of the tables,
wherein the hybrid partitioned table classifies the data constituting the tables with respect to each of the partitions, classify the data constituting the partitions into hot data and cold data, based on attribute of data, with respect to each of the partitions, and store the hot data and the cold data in different logical storage spaces.

13. The hybrid database management system of claim 12, wherein when data is classified into the hot data if the data attribute of the data is within a preset recent period and data is classified into the cold data if the data attribute of the data is out of the preset recent period, the hybrid partitioned table reclassifies the data into the cold data if it is determined that the data classified into the hot data is out of the preset recent period.

14. The hybrid database management system of claim 13, wherein when the attribute of the data constituting the tables is changed based on the preset recent period, the hybrid partitioned table changes a logical storage space of the data, the attribute of which is changed.

15. The hybrid database management system of claim 12, wherein the hot data is data satisfying a preset usage condition among the data constituting the tables, and the cold data is data except for the data except for the hot data among the data constituting the tables.

16. The hybrid database management system of claim 15, wherein when the attribute of the data constituting the tables is changed based on the preset usage condition, the hybrid partitioned table changes a logical storage space of the data, the attribute of which is changed from the hot data to the cold data.

17. A method of managing tables in a hybrid database management system, the method comprising:
classifying data constituting tables with respect to each of partitions;
classifying the data constituting the partitions into hot data and cold data, based on data attribute, with respect to each of the partitions;
storing the hot data and the cold data in different logical storage spaces;
checking data attributes of the hot data and the cold data at preset periods and reclassifying the hot data and the cold data based on the checked data attributes; and
updating logical storage spaces of the reclassified hot data and the reclassified cold data.

18. The method of claim 17, wherein the classifying of the data comprises, when data is classified into the hot data if the data attribute of the data is within a present recent period and data is classified into the cold data if the data attribute of the data is out of the preset recent period, reclassifying the data into the cold data if it is determined that the data classified into the hot data is out of the preset recent period.

19. The method of claim 18, wherein the reclassifying of the data comprises reclassifying past data into cold data when the past data is out of a preset period among hot data classified at preset periods, and
the updating of the logical storage spaces comprises changing the logical storage space of the data reclassified into cold data.

20. A method of managing tables in a hybrid database management system, the method comprising:
classifying, by a hybrid partitioned table, data into hot data and cold data, based on data attribute, in units of data constituting tables with respect to each of the tables;
storing the hot data and the cold data in different logical storage spaces;
determining whether the data attribute is changed; and
when it is determined that the data attribute is changed, changing a logical storage space of the data.
